(19) United States
(12) Patent Application Publication
(10) Pub. No.: US 2009/0106284 A1
(43) Pub. Date: Apr. 23, 2009

(54) IMAGE FORMING APPARATUS AND JOB INFORMATION MANAGEMENT METHOD

(76) Inventor: Koji KITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/252,933

(22) Filed: Oct. 16, 2008

(30) Foreign Application Priority Data
Oct. 19, 2007 (JP) 2007-272430

(51) Int. Cl. G06F 7/00; G06F 1/26; G06F 17/30

(52) U.S. Cl. 707/101; 713/300; 707/E17.01; 707/E17.044

(57) ABSTRACT

Disclosed an image forming apparatus including: a first storage section to store job information of a completely executed job; a nonvolatile second storage section to store the job information, the second storage section being larger in capacity than the first storage section; and a control section to compress the job information to store the compressed job information into the second storage section, and to manage the job information.

### BACKGROUND

1. Field of the Invention

The present invention relates to an image forming apparatus and a job information management method.

2. Description of Related Art

In recent years, there has been known an image forming apparatus such as a printer, a scanner, a facsimile, a copier, and a multi function peripheral (MFP) having various functions such as an image forming function, a copying function, a scanner function, and a facsimile function.

The image forming apparatus manages information (hereinafter referred to job information) of a job to be executed by the image forming apparatus with the aim of storing the job information of a completely executed job into a memory, counting the pieces of the job information according to user's intended purpose or a predetermined item, and displaying a counting result or a history of the job information.

For example, Japanese Patent Application Laid-Open Publication No. 2004-178325 discloses a job account server which manages the job information output from a client computer to a printer by setting a count item for counting the pieces of the job information from a client computer, obtaining the job information from the recorded job information in a job-log recording section based on the set count item, counting pieces of history information included in the obtained job information, and outputting the counting result of the pieces of counted history information into the client computer.

However, in Japanese Patent Application Laid-Open Publication No. 2004-178325, the job information is stored in an external apparatus provided outside of the information apparatus, and managed in the external apparatus. Therefore, the image forming apparatus of Japanese Patent Application Laid-Open Publication No. 2004-178325 is susceptible to an effect of a communication status for transmitting and receiving the job information between the image forming apparatus and the external apparatus, and easily goes into a storage waiting status where the job information can not be stored into the memory, or goes into a read waiting stats where the job information can not be read from the memory. Thus, the image forming apparatus of Japanese Patent Application Laid-Open Publication No. 2004-178325 has an unstable function because a speed of communication between the image forming apparatus and the memory to store the job information possibly slows down.

Moreover, according to Japanese Patent Application Laid-Open Publication No. 2004-178325, even when the job information is stored in the memory inside the image forming apparatus, not in the external apparatus, since there is a limit of memory capacity, the image forming apparatus has problems that the job information is deleted in order from the oldest one, and that if the memory is a volatile memory, the job information stored in the memory disappear when a power is turned off. Furthermore, according to Japanese Patent Application Laid-Open Publication No. 2004-178325, even when the job information of the completely executed job is stored in a nonvolatility memory (for example, an HDD and the like), since there is also a limit of memory capacity in the nonvolatility memory, a problem that the memory is occupied occurs.

### SUMMARY

The present invention is achieved in view of above problems, and an object of the present invention is to prevent operation speeds of reading and writing the job information from slowing down and to store the large amount of the job information so as to improve a function of managing the job information.

According to a first aspect of the invention, an image forming apparatus includes: a first storage section to store job information of a completely executed job; a nonvolatile second storage section to store the job information, the second storage section being larger in capacity than the first storage section; and a control section to compress the job information to store the compressed job information into the second storage section, and to manage the job information.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a configuration drawing of an image forming apparatus according to a first embodiment;

FIG. 2 is a drawing showing a configuration of inside of RAM;

FIG. 3 is a drawing showing examples of a history file, a compressed history file, and an expanded history file;

FIG. 4 is a drawing showing an example of a first job history displaying screen;

FIG. 5 is a drawing showing an example of a second job history displaying screen;

FIG. 6 is a flowchart of a processing of storing a job history data stored in an intermediate buffer into an HDD, in the first embodiment;

FIG. 7 is a flowchart of a job history data displaying processing;

FIG. 8 is a flowchart of a job history data displaying processing (continuous from FIG. 7);

FIG. 9 is a flowchart of a processing of storing the job history data stored in an intermediate buffer into an HDD, in the second embodiment; and

FIG. 10 is a flowchart of a processing of compressing the job history data stored in the HDD to store it.

### DETAILED DESCRIPTION OF THE PREFERRED EMBODIMENT

### First Embodiment

An embodiment of the present invention will be described in detail with reference to drawings below.

Firstly, a configuration will be explained.

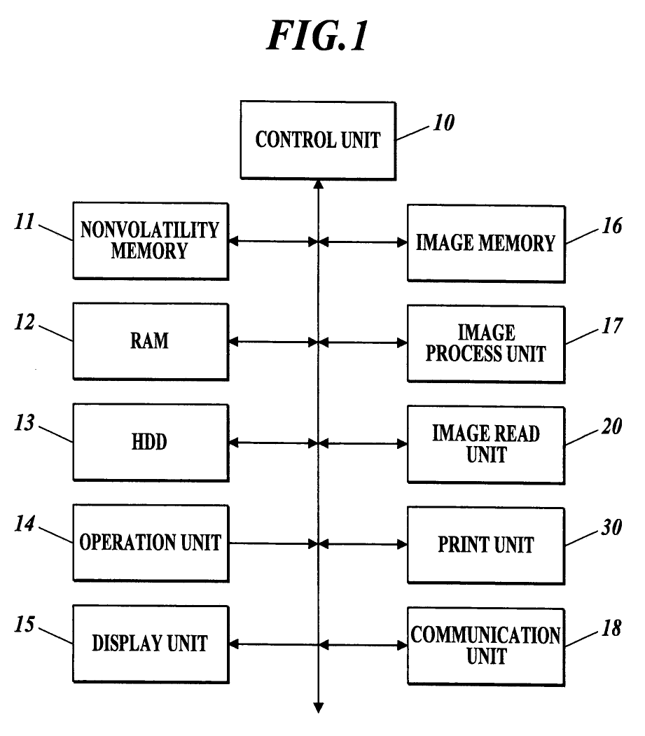

FIG. 1 is a configuration drawing of an image forming apparatus according to the first embodiment.

As shown in FIG. 1, the image forming apparatus includes a control unit 10, a nonvolatility memory 11, a Random Access Memory (RAM) 12, a Hard Disk Drive (HDD), an operation unit 14, a display unit 15, an image memory 16, an image process unit 17, a communication unit 18, an image read unit 20, a print unit 30 and the like, and these units are electrically connected to one another.

The control unit 10 includes a Central Processing Unit (CPU) and the like, and expands a system program, various control programs and various pieces of data, which are stored in the nonvolatility memory 11, into the RAM 12 to collectively control each unit of the image forming apparatus in cooperation with these programs and data.

Moreover, the control unit 10 has a timer function as a time-keeping section to keep a time and date. The control unit 10 executes a job history data storing processing and a job history data displaying processing to realize a function as a control section to manage job history data. By the job history data storing processing, job information (herein after referred to job history data) of a completely executed job is stored in the RAM 12 and the HDD 13. By the job history data displaying processing, the job history data is displayed on the display unit 15 according to an instruction from the operation unit 14.

When the control unit 10 executes the job history data storing processing, if the job history data is stored into the HDD 13, the control unit 10 temporarily stores the job history data into an intermediate buffer in the RAM to be described hereinafter, stores the job history data stored in the intermediate buffer into the HDD 13 every time a predetermined time has passed as earlier time and date than previously set time and date, and compresses the job history data stored in the HDD 13 to store the compressed job history data.

When the control unit 10 executes the job history data displaying processing, the control unit 10 stores the job history data stored in the intermediate buffer into the HDD 13 if the control unit 10 receives an instruction to display the job history data stored in the HDD 13 on the display unit 15. The CPU control unit 10 stores the number of pieces of the job history data stored in a job history management area in RAM 12 to be described hereinafter. Then the control unit 10 searches for the job history data stored in the HDD 13 based on a predetermined set condition, expands the job history data if it is compressed, stores the searched uncompressed job history data in the job history management area, and displays the job history data stored in the job history management area on the display unit 15. After that, when the CPU ends the display of the job history data stored in the HDD 13, the control unit 10 extracts the pieces of the job history data of the stored number in order from the latest job history data among the job history data stored in the HDD 13 to store the extracted job history data in the job history management area. Moreover, the control unit 10 deletes the expanded job history data existing in the HDD 13 to put a state of the job history management area back into a state before the job history data stored in the HDD 13 is displayed on the display unit 15.

The nonvolatility memory 11 may composed of a Read Only Memory (ROM), an HDD, and the like. The nonvolatility memory 11 stores system programs to be executed by the control unit 10, various control programs, programs for executing the job history data storing processing and the job history data displaying processing, data regarding these programs, and the like.

The RAM 12 provides a work area into which the various programs to be executed by the control unit 10 and the data regarding these programs are temporarily stored, and includes a reserve job management area 12a, a job history management area 12b, and an intermediate buffer 12c. The RAM 12 stores the job data of the completely executed job as the job history data to realize a function as a first storage section enabling writing and reading the job history data faster than the HDD 13.

Incidentally, in the first embodiment, the first storage section is explained as the RAM 12, but not limited to it. The first storage section may be other than the RAM 12 as long as the job history data can be written to and read from the first storage faster than a second storage section (the HDD 13 in the first embodiment).

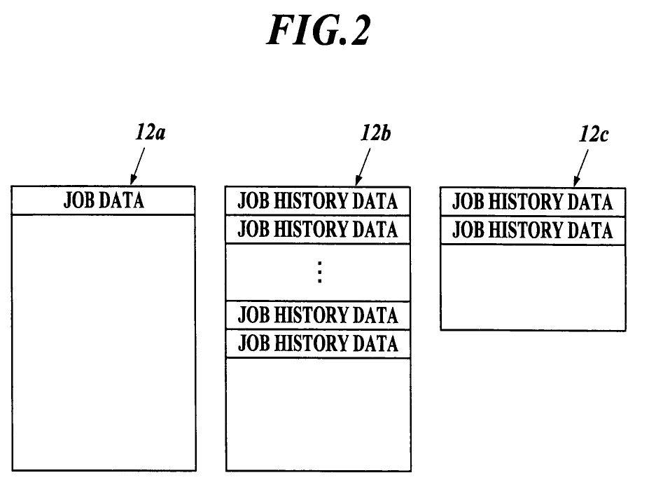

FIG. 2 shows a configuration of inside of RAM.

As shown in FIG. 2, RAM12 includes the reserve job management area 12a, the job history management area 12b, and the intermediate buffer 12c.

The reserve job management area 12a is an area previously set in the RAM 12, to which a job data of the job, which is reserved but not completely executed, is stored.

The job history management area 12b is an area previously set in the RAM 12, to which a job data of the completely executed job is stored as the job history data.

The intermediate buffer 12c is an area previously set in the RAM 12, which is smaller than the job history management area 12b, and to which the pieces of the job history data, which is to be stored in the HDD 13, of the previously set number is temporarily stored.

The HDD 13 stores a history file 13a, a history file which is compressed (compressed history file) 13b, and a compressed history file which is expanded (expanded history file) 13c. In other words, the HDD 13 stores uncompressed job history data and compressed job history data, and realizes a function as the second storage section which is nonvolatile and larger in capacity than the RAM 12.

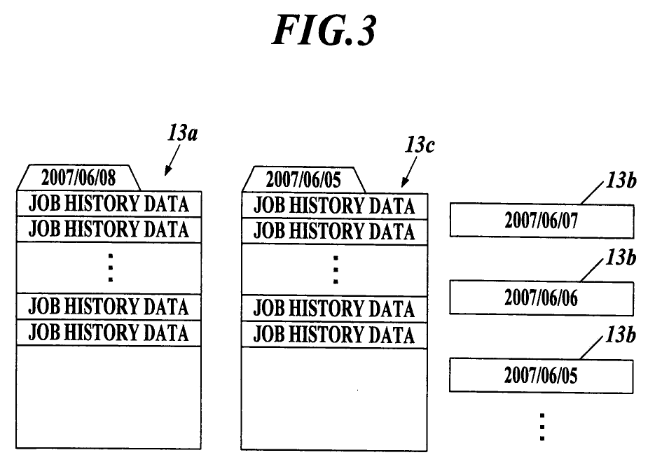

Incidentally, in the first embodiment, the second storage section is explained as the HDD 13, but not limited to it. The second storage section may be other than the HDD 13 as long as it is a nonvolatility memory and larger in capacity than the first storage section (the RAM 12 in the first embodiment). FIG. 3 shows examples of the history file 13a, the compressed history file 13b, and the expanded history file 13c, which are stored in the HDD 13.

As FIG. 3 shows, the history file 13a stores a plurality of pieces of the job history data which are sorted in units of days in an uncompressed state. Incidentally, the job history data may be information of power-on/off status, in addition to the job data of completely executed job.

The compressed history file 13b is the history file which is compressed, and an aggregate of a plurality of pieces of the job history data which are compressed in a predetermined format and sorted in units of days.

The expanded history file 13c is the compressed history file which is expanded, and an aggregate of pieces of the job history data generated by expanding a plurality of pieces of the job history data which is compressed and sorted in units of days.

The operation unit 14 includes a power switch as a power supply instruction section to instruct to supply a power to the image forming apparatus, and various operation hard keys such as a copy start key and a numeric keypad. The operation unit 14 outputs an operation signal of the operation hard keys to the control unit 10. Moreover, the operation unit 14 includes a touch panel provided so as to cover an LCD of the display unit 15. The operation unit 14 detects coordinates which is specified by touching on a principle to read coordinates such as an electromagnetic induction method, a magnetostrictive method, and a pressure sensitive method, to output detected coordinates to the control unit 10. The operation unit 14 functions as an input section to receive an instruction to display the job history data stored in the RAM 12 or the HDD 13 on the screen displayed on the display unit 15.

The display unit 15 includes a display screen such as Liquid Crystal Display (LCD), Video Random Access Memory (VRAM) which temporarily stores the data for displaying an operation screen on the display screen, and the like. The display unit 15 displays various necessary screens according to the data written in the VRAM by the control unit 10. Moreover, the display unit 15 realizes a function as the display section to display a first job history display screen G1 and a second job history display screen G2, which display the job history data, on the display screen, according to an instruction from the control unit 10.

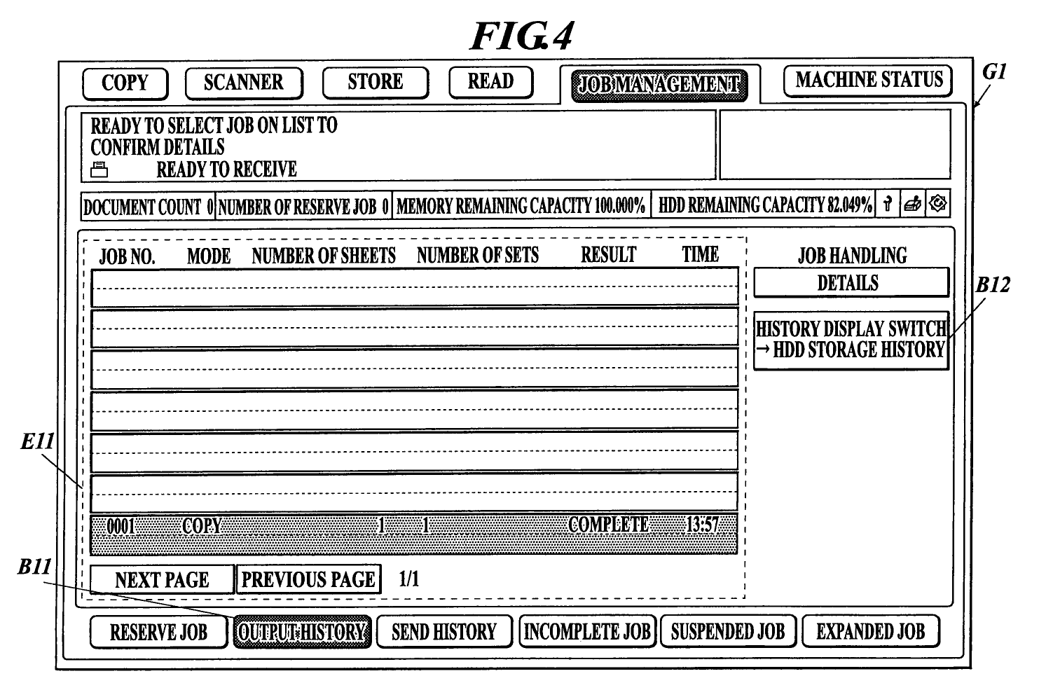

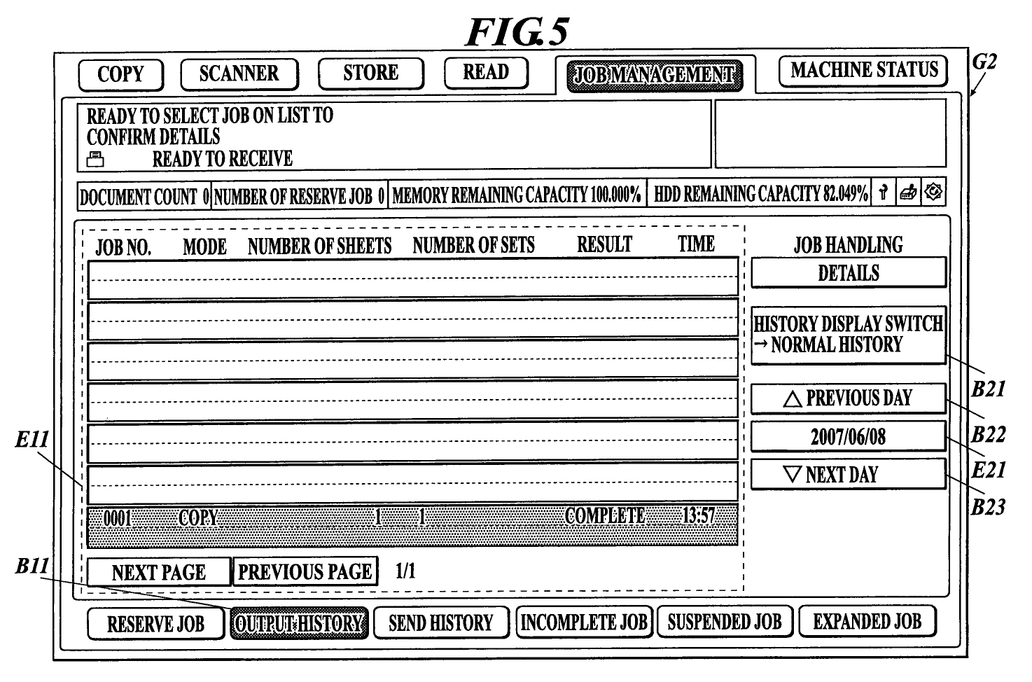

FIG. 4 shows an example of the first job history display screen G1, and FIG. 5 shows an example of the second job history display screen.

As FIG. 4 shows, the first job history display screen G1 includes an output history button B11, a history display switching button B12, a job history display area E11, and the like.

The output history button B11 receives an instruction to display the job history data of the completely executed job on the job history display area E11.

The history display switching button B12 switches the job history data displayed on the job history display area E11 to the job history data stored in the HDD 13, and receives an instruction to display the second job history display screen G2. In other words, the job history data displayed on the job history display area E11 of the first job history display screen G1 is the job history data stored in the job history management area 12b of the RAM 12.

As shown in FIG. 5, the second job history display screen G2 includes an output history button B11 and a job history display area E11 which are same as those of the first job history display screen G1, a history display switching button B21, a date display area E21, a previous day button B22, a next day button, and the like.

The history display switching button B21 switches the job history data displayed in the job history display area E11 to the job history data stored in the job history management area 12b of the RAM 12, and receives an instruction to display the first job history display screen G1. In other words, the job history data displayed in the job history display area E11 of the second job history display screen G2 is the job history data stored in the HDD 13.

In the data display area E21, the data of the job history data displayed in the job history display area E11 is indicated. The previous day button B22 receives an instruction to display the job history data, which is stored in the HDD 13, of the day before the date displayed in the date display area E21. The next day button B23 receives an instruction to display the job history data, which is stored in the HDD 13, of the data after the date displayed in the date display area E21.

The image memory 16 is composed of a dynamic RAM (DRAM), and includes a compression memory which temporarily stores compressed image data and a page memory which temporarily stores uncompressed image data to be printed out before printout.

The image process unit 17 compresses image data output from the image read unit 20 and image data transmitted through the communication unit 18 to temporarily store the image data in the compression memory of the image memory 16.

The communication unit 18 includes various interfaces such as a NIC, a modem, and a USB, and transmits/receives information to/from external equipments each other on a network.

The image read unit 20 is provided with a light source, a photoelectric conversion element such as a Charge Coupled Devices (CCD), and the like, in the lower side of a contact glass. A document put on the contact glass is light-scanned by the image read unit 20, then reflected light is photoelectrically converted by CCD to be digitally converted for obtaining the image data of the document.

The print unit 30 includes a paper feed unit (not shown in the drawings) to feed various papers. The print unit 30 forms an image on a specified paper based on the image data stored in the page memory, for which the control section 10 has instructed printing. Incidentally, any image forming method such as an electrophotographic method, an inkjet method, and the like may be adopted.

Next, an operation of the first embodiment will be described.

Firstly, the job history data storing processing of the first embodiment will be explained.

Incidentally, the job history data storing processing is executed by the control section 10 in cooperation with the program of the job history data storing processing stored in the nonvolatility memory 11, the RAM 12, and the HDD13.

The control unit 10 generates the job history data from the job data of the completely executed job when the execution of the job is completed. The control unit 10 then stores the generated job history data in the job history management area 12b of the RAM 12, and stores a copy of the job history data into the intermediate buffer 12c.

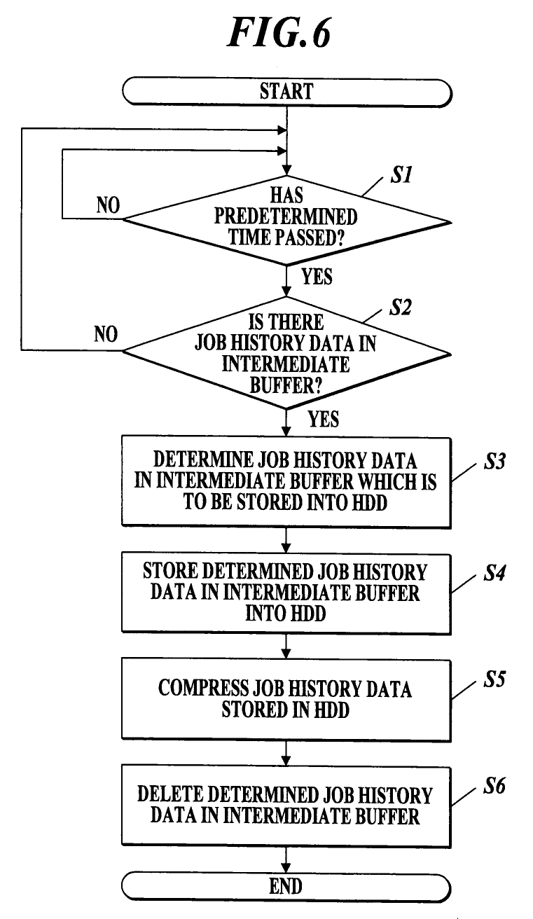

After that, the control unit 10 executes a processing of storing the job history data stored in the intermediate buffer 12c into the HDD 13. FIG. 6 shows a flowchart of the processing of storing the job history data stored in the intermediate buffer 12c into the HDD 13.

As shown in FIG. 6, the control unit 10 firstly judges whether or not a predetermined time has passed when the control unit 10 executes the processing of storing the job history data stored in the intermediate buffer 12c into the HDD 13 (Step S1).

The predetermined time is set based on a minimum time interval during which the job history data is generated, and based on the number of pieces of the job history data storable into the intermediate buffer 12c. The predetermined time is set in order to prevent the case that the job history data can not be stored in the intermediate buffer 12c. The predetermined time is used to judge whether or not the job history data is the job history data executed at an earlier time and date than previously set time and date. Therefore, in Step S1 where it is judged whether or not the predetermined time has passed, for example, it may be judged whether or not a previously set time has passed since the job history data stored in the intermediate buffer 12c is stored into the HDD13, and whether or not a date of storing the job history data stored in the intermediate buffer 12c into the HDD13 is a previously set date (current date).

When the predetermined time has not passed (Step S1; No), the control unit 10 waits until the predetermined time has passed (return to Step S1).

When the predetermined time has passed (Step S1; Yes), the control section 10 judges whether or not there is the job history data in the intermediate buffer 12c (Step S2). When there is not the job history data (Step S2; No), the process by the control section 10 returns to Step S1.

When there is the job history data in the intermediate buffer 12c (Step S2; Yes), the control unit 10 determines the job history data stored in the intermediate buffer 12c as the job history data to be stored in the HDD 13 (Step S3).

The control unit 10 generates a copy of the job history data determined in Step S3 to store the copied job history data into the HDD 13 (Step S4).

Then the control unit 10 compresses the job history data stored in the HDD 13 to store the data as the compressed history file into the HDD 13, and deletes, from the HDD 13, the job history data from which the compressed history file has been generated (Step S5).

Moreover, the control unit 10 deletes the job history data in the intermediate buffer 12c, which is determined in Step S3 (Step S6), and ends the process shown in FIG. 6.

In other words, the process shown in FIG. 6 is repeatedly executed every time the predetermined time has passed, namely at regular intervals.

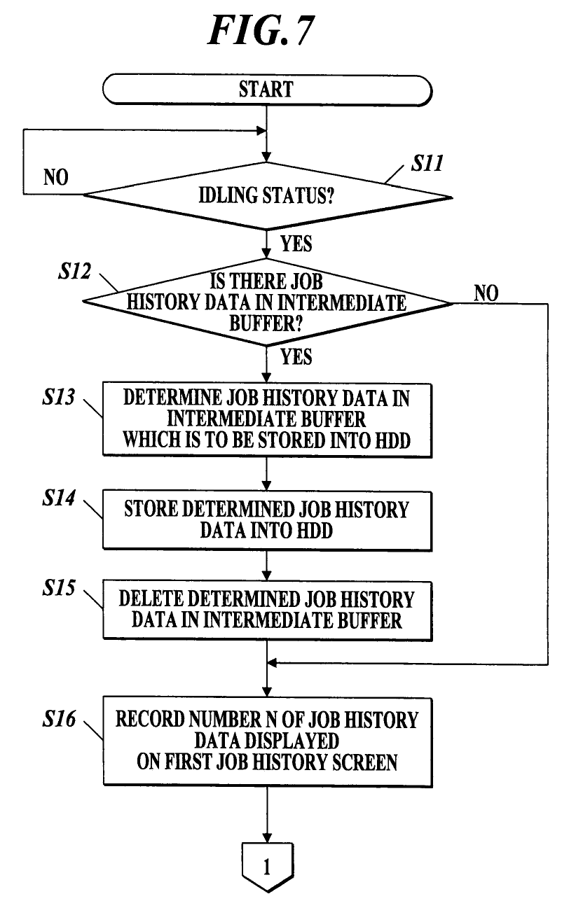

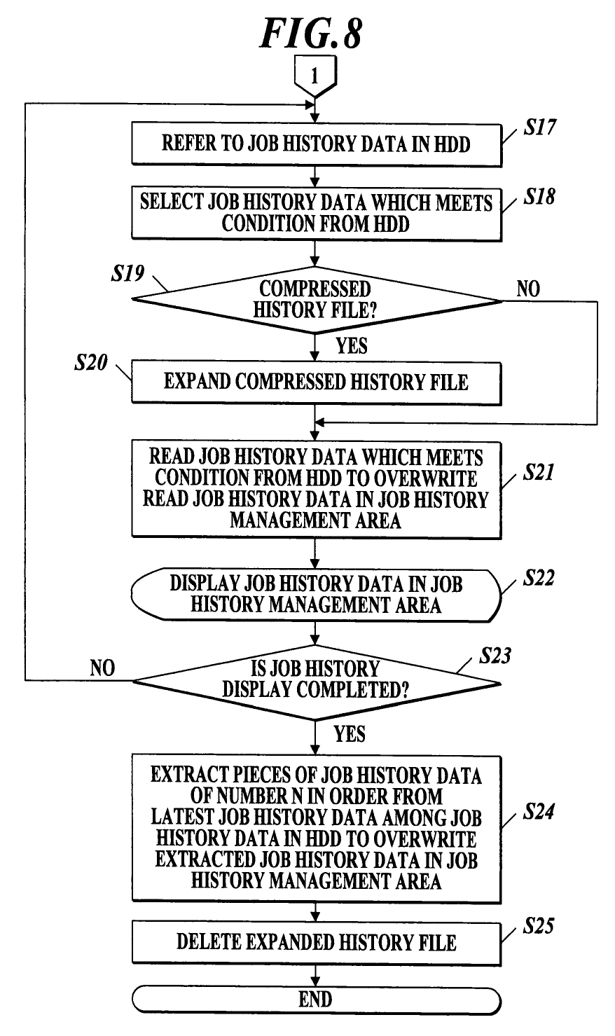

FIGS. 7 and 8 show flowcharts of the job history data displaying processing of the first embodiment. Incidentally, the processes shown in FIGS. 7 and 8 are executed by the control unit 10 in cooperation with the program of the job history data displaying processing stored in the nonvolatility memory 11, the RAM 12, and the HDD 13.

When the history display switching button B12 in the first job history display screen G1 displayed on the display unit 15 is depressed, the control unit 10 judges whether or not the image forming apparatus is in idling status (Step S11). When the image forming apparatus is not in idling status (Step 11; No), the control unit 10 waits until the image forming apparatus goes into idling status.

When the image forming apparatus is in idling status (Step 11; Yes), the control unit 10 judges whether or not there is the job history data in the intermediate buffer 12c (Step S12). When there is not the job history data in the intermediate buffer 12c (Step S12; No), the process by the control unit 10 shifts to Step S16.

When there is the job history data in the intermediate buffer 12c (Step S12; Yes), the control unit 10 determines the job history data stored in the intermediate buffer 12c as the job history data to be stored in the HDD 13 (Step S13).

The control unit 10 copies the job history data determined in Step S13 to store the copied job history data into the HDD 13 (Step S14).

The control unit 10 deletes the job history data in the intermediate buffer 12c, which is determined in Step S13 (Step S15).

By executing Steps 12-15, the pieces of the job history data of all of the jobs completely executed by the time the image forming apparatus goes into idling status is stored into the HDD 13.

After the judgment in Step 12 results in No, or after the process in Step S15 ends, the control unit 10 stores the number N of pieces of the job history data displayed in the job history display area E11 of the first job history display screen G1, namely the number of pieces of the job history data stored in the job history management area 12b of the RAM 12 (Step S16).

After Step S16, the control unit 10 refers to the job history data stored in the HDD 13 (Step 17), and searches for the job history data meeting a previously set condition from the referred job history data in the HDD 13 (Step S18). The control section 10 judges whether or not the searched job history data is the job history data stored in the compressed history file (Step S19).

When the searched job history data is the job history data stored in the compressed history file (Step S19; Yes), the control unit 10 expands the compressed history file in which the job history data is stored, to generate the expanded history file (Step S20).

When the searched job history data is not the job history data stored in the compressed history file (Step S19; No), or after Step S20, the control unit 10 reads the job history data meeting the previously set condition from the HDD 13 to copy the read job history data, and then overwrites the copy of the read job history data in the job history management area 12b (Step S21).

The control unit 10 displays the second job history display screen G2 on the display unit 15, and displays the job history data stored in the job history management area 12b on the job history display area E11 of the second job history display screen G2 (Step S22).

The control unit 10 judges whether or not the display of the job history data stored in the HDD 13 is completed according to whether or not the history display switching button B21 on the second job history display screen G2, the previous day button B22 or the net day button B23 is depressed (Step S23).

When the previous day button B22 or the net day button B23 is depressed, namely the display of the job history data stored in the HDD 13 is not completed (Step S23; No), the process by the control unit 10 returns to Step S17.

When the history display switching button B21 is depressed, namely the display of the job history data stored in the HDD 13 is completed (Step S23; Yes), the control unit 10 reads the pieces of job history data of the number N, which is stored in Step S16, in order from the job history data of a latest date among the job history data stored in the HDD 13 to copy the read job history data, and overwrites the copy of pieces of the read job history data of number N in the job history management area 12b of the RAM 12 (Step S24). After that, the control unit 10 deletes the expanded history file (Step S25), and ends a sequence of above processes.

According to the first embodiment, the following advantages are obtained.

Specifically, since the image forming apparatus includes the RAM 12 to store the job history data, and the nonvolatility HDD 13 to store the compressed job history data, which is larger in capacity than the RAM 12, the job history data can be doubly managed.

Moreover, since the image forming apparatus keeps a certain operation speed without being affected by an influence of the external equipment as writing and reading the stored job history data, and since the HDD 13 can realizes storage of large amount, it is possible to improve a management operation of the job history data.

Furthermore, particularly, since the job history data can be compressed to be stored at earlier time and date than the predetermined time and date, it is possible to compress the job history data having low use frequency such as reference frequency of past in order to effectively use a capacity of the HDD 13. Thus, it is possible to prevent the job history data, which has high use frequency, of comparatively new date, from being compressed so as to omit an expansion operation when the data is used.

Moreover, if the image forming apparatus concurrently performs other processes, a high speed operation is required. By temporarily storing the job history data into the intermediate buffer of the RAM 12 where the job history data can be read and written speedily, and by compressing the job history data stored in the RAM 12 to store the compressed job history data into the HDD 13 every time the predetermined time has passed, it is possible to reduce a frequency of writing the job history data into the HDD 13 while preventing a capacity of the HDD 13 from being occupied, so that other operations can be executed instantly.

Furthermore, when the job history data stored in the HDD 13 is displayed on the display unit 15, by expanding the job history data to be displayed if it is compressed (if it is the job history data stored in the compressed history file) to allow it to be the uncompressed job history data, and by temporarily storing the uncompressed job history data into the RAM 12 enabling reading and writing faster than the HDD 13 to display the job history data stored in the RAM 12, it is possible to allow an execution speed of processes after displaying the job history data to be faster than that of the case of reading the job history data without storing it into the RAM 12.

### Second Embodiment

The second embodiment of the present invention will be described in detail with reference to the drawings below.

Since a configuration drawing of the image forming apparatus according to the second embodiment is almost same as the configuration drawing of the image forming apparatus according to the first embodiment shown in FIG. 1, an illustration thereof is omitted, and only differences between the configurations will be explained.

The control unit 10 according to the second embodiment has a timer function as a time-keeping section to keep a time and date. Moreover, the control unit 10 executes a job history data storing processing and a job history data displaying processing to realize a function as a control section to manage the job history data. In the job history data storing processing, job information (job history data) of a completely executed job is stored into a RAM 12 and the HDD 13. In the job history data displaying processing, the job history data is displayed on the display unit 15 according to an instruction from an operation unit 14.

When the job history data storing processing is executed, if the job history data is stored into the HDD 13, the control unit 10 temporarily stores the job history data in an intermediate buffer of the RAM 12, and stores the job history data stored in the intermediate buffer into the HDD 13 every time a predetermined time has passed. Then, when the control unit 10 receives an instruction to supply a power from a power switch (for example, the power switch is turned on), or when the date has changed, the control unit 10 compresses the job history data stored in the HDD 13 to store the compressed job history data into the HDD 13.

Incidentally, since a configuration of the RAM 12, a configuration of the HDD 13, the first job history display screen G1 and the second job history display screen G2 are same as those of the first embodiment, illustrations and explanations thereof are omitted.

Next, an operation of the second embodiment will be explained.

Firstly, the job history data storing processing according to the second embodiment will be explained.

Incidentally, the job history data storing processing is executed by the control unit 10 in cooperation with the program of the job history data storing processing stored in the nonvolatility memory 11, the RAM 12, and the HDD 13.

When the job is completely executed, the control unit 10 generates the job history data from the job data of the completely executed job. Then the control unit 10 stores the generated job history data into the job history management area 12b of the RAM 12, and stores the copy of the generated job history data into the intermediate buffer 12c.

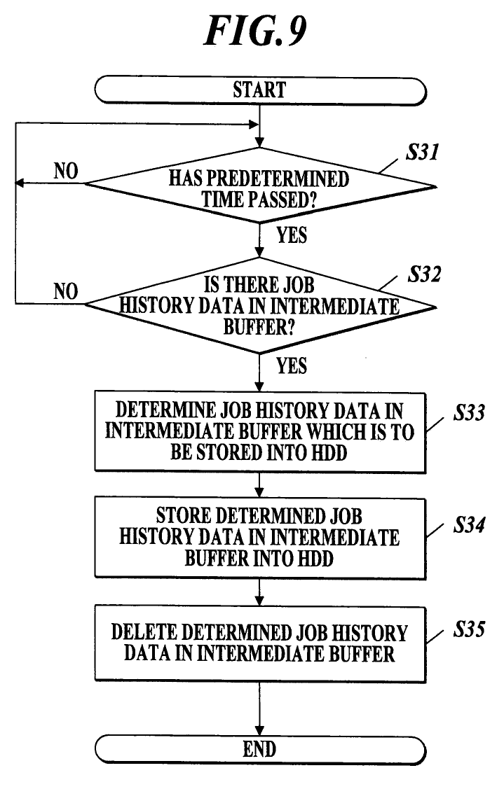

After that, the control unit 10 executes the processing of storing the job history data stored in the intermediate buffer 12c into the HDD 13. FIG. 9 shows a flowchart showing the processing of storing the job history data stored in the intermediate buffer 12c into the HDD 13.

As Steps S31-S33 are same as Steps S1-S3 of the first embodiment shown in FIG. 6, explanations thereof are omitted.

The control unit 10 generates the copy of the job history data determined in Step S33 to store the copied job history data into the HDD 13 (Step S34).

Then the control unit 10 deletes the job history data in the intermediate buffer 12c, which is determined in Step S33, and ends the process shown in FIG. 9. Incidentally, the process shown in FIG. 9 is repeatedly executed every time the predetermined time has passed, namely at regular intervals.

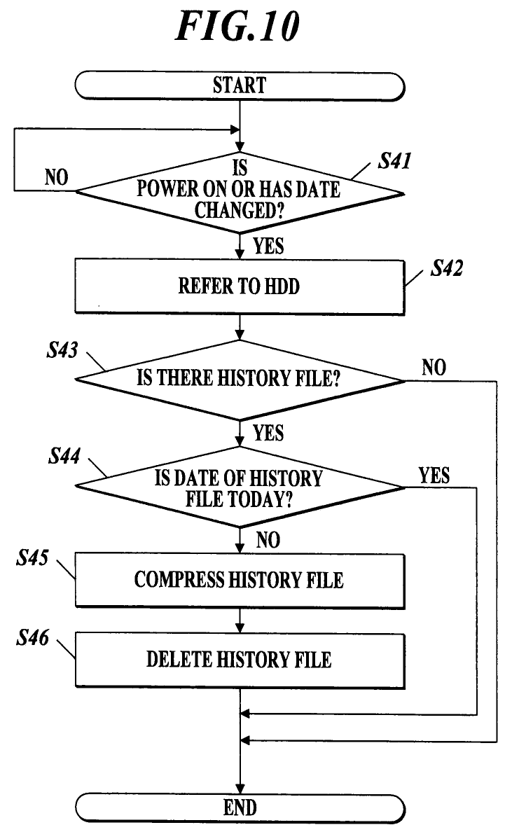

After that, the processing of compressing the job history data stored in the HDD 13 to store the compressed job history data is executed. FIG. 10 shows a flowchart showing the processing of compressing the job history data stored in the HDD 13 to store the compressed job history data.

The control unit 10 judges whether or not the power switch is turned on, and whether or not the date has changed (Step S41). When the power switch is not turned on and the date has not changed as a result of the judgment (Step S41; No), the process by the control unit 10 returns to Step S41.

When the power switch is turned on, or when the date has changed, as a result of the judgment (Step S41; Yes), the control unit 10 refers to the HDD 13 (Step S42) to judge whether or not there is the history file storing the uncompressed job history data (Step S43). When there is not the history file as a result of the judgment (Step S43; No), the process by the control unit 10 shown in FIG. 10 ends.

When there is the history file (Step S43; Yes), the control unit 10 judges whether or not the date of the history file is current date (today) (Step S44). When the date of the history file is the current date (Step S44; Yes), the control unit 10 ends the process shown in FIG. 10.

When the date of the history file is not the current date (Step S44; No), the control unit 10 compresses the history file to generate the compressed history file, and store the generated compressed history file into the HDD 13 (Step S45).

Then the control unit 10 deletes the history file from which the compressed history file has been generated (Step S46), and ends the process shown in FIG. 10.

As the job history data displaying processing is same as that of the first embodiment, an illustration and an explanation thereof are omitted.

According to the second embodiment, the following advantages are obtained.

Specifically, similar to the first embodiment, since the image forming apparatus includes the RAM 12 to store the job history data, and the nonvolatility HDD 13 to store the compressed job history data, which is larger in capacity than the RAM 12, the job history data can be doubly managed.

Moreover, since the image forming apparatus keeps a certain operation speed without being affected by an influence of the external equipment as writing and reading the stored job history data, and since the HDD 13 can realizes storage of large amount, it is possible to improve a management operation of the job history data.

Furthermore, since the job history data can be compressed to be stored at earlier time and date (for example, at the time when the power switch is turned on, or at the time when the date has changed) than the predetermined time and date, it is possible to compress the job history data having low use frequency such as reference frequency of past to effectively use a capacity of the HDD 13. Thus, it is possible to prevent the job history data, which has high use frequency, of comparatively new date, from being compressed in order to omit an expansion operation when the data is used. Particularly, since it is possible to compress the job history data to store the compressed job history data when the power switch is turned on or when the date has changed, it becomes possible to perform the compression of the job history data, before high speed operations are required because the image forming apparatus executes other processes concurrently, so as to prevent other processes from interrupting the compression.

Moreover, similar to the first embodiment, when the job history data stored in the HDD 13 is displayed on the display unit 15, by expanding the job history data to be displayed if it is compressed (if it is the job history data stored in the compressed history file) to allow it to be the uncompressed job history data, and by temporarily storing the uncompressed job history data into the RAM 12 enabling reading and writing faster than the HDD 13 to display the job history data stored in the RAM 12, it is possible to allow an execution speed of processes after displaying the job history data to be faster than that of the case of reading the job history data without storing it into the RAM 12.

Furthermore, the present invention is not limited to the contents of the first and second embodiments described above, but the embodiment can be suitably modified without departing from the sprit and the scope of the present invention.

According to the preferred embodiment of the present invention, an image forming apparatus includes: a first storage section to store job information of a completely executed job; a nonvolatile second storage section to store the job information, the second storage section being larger in capacity than the first storage section; and a control section to compress the job information to store the compressed job information into the second storage section, and to manage the job information.

Preferably, the control section compresses the job information completely executed at earlier time and date than previously set time and date to store the compressed job information into the second storage section.

Preferably, the control section compresses the job information stored in the first storage section to store the compressed job information into the second storage section every time a predetermined time has passed.

Preferably, the control section stores the job information stored in the first storage section into the second storage section, and compresses the job information stored in the second storage section to store the compressed job information into the second storage section at a predetermined timing.

Preferably, the image forming apparatus further includes a power supply instruction section to instruct to supply a power to the image forming apparatus, wherein the control section compresses the job information stored in the second storage section to store the compressed job information into the second storage section, at the time when the power supply instruction section instructs to supply a power, as the predetermined timing.

Preferably, the image forming apparatus further includes a time-keeping section to keep a time and date, wherein the control section compresses the job information stored in the second storage section to store the compressed job information into the second storage section, at the time when a date has changed by the time-keeping section, as the predetermined timing.

Preferably, the image forming apparatus further includes: a display section to display the job information; and an input section to receive an instruction to display the job information stored in the second storage section on the display section, wherein when the control section receives the instruction to display the job information stored in the second storage section from the input section, the control section searches for the job information for which the instruction to display the job information stored in the second storage section is received, expands the job information if the job information is compressed, stores the expanded job information or the searched uncompressed job information into the first storage section, and displays the job information stored in the first storage section on the display section.

Moreover, according to the preferred embodiment of the present invention, a method for managing job information in an image forming apparatus which includes a first storage section and a second storage section larger in capacity than the first storage section, the method includes: storing the job information of a completely executed job into the first storage section; storing the job information stored in the first storage section into the second storage section; and compressing the job information stored in the second storage section to store the compressed job information into the second storage section.

Preferably, the job information stored in the first storage section is stored into the second storage section every time a predetermined time has passed.

Preferably, the job information stored in the second storage section is compressed to be stored into the second storage section at the time when the image forming apparatus is turned on.

Preferably, the job information stored in the second storage section is compressed to be stored into the second storage section at the time when a date has changed.

Preferably, after the job information stored in the second storage section is compressed to be stored into the second storage section, the job information which has not compressed is deleted from the second storage section.

Preferably, the method further includes searching the job information stored in the second storage section, expanding the job information to store the expanded job information into the first storage section if the job information is compressed or storing the searched job information into the first storage section without expanding if the job information is not compressed, and displaying the job information stored in the first storage section on the display section, when an instruction to display the job information stored in the second storage section is received.

The present U.S. patent application claims a priority under the Paris Convention of Japanese patent application No. 2007-272430 filed on Oct. 19, 2007, which shall be a basis of correction of an incorrect translation.

What is claimed is:

1. An image forming apparatus comprising:
a first storage section to store job information of a completely executed job;
a nonvolatile second storage section to store the job information, the second storage section being larger in capacity than the first storage section; and
a control section to compress the job information to store the compressed job information into the second storage section, and to manage the job information.

2. The image forming apparatus of claim 1, wherein the control section compresses the job information completely executed at earlier time and date than previously set time and date to store the compressed job information into the second storage section.

3. The image forming apparatus of claim 1, wherein the control section compresses the job information stored in the first storage section to store the compressed job information into the second storage section every time a predetermined time has passed.

4. The image forming apparatus of claim 1, wherein the control section stores the job information stored in the first storage section into the second storage section, and compresses the job information stored in the second storage section to store the compressed job information into the second storage section at a predetermined timing.

5. The image forming apparatus of claim 4 further comprising a power supply instruction section to instruct to supply a power to the image forming apparatus,
wherein the control section compresses the job information stored in the second storage section to store the compressed job information into the second storage section, at the time when the power supply instruction section instructs to supply a power, as the predetermined timing.

6. The image forming apparatus of claim 4 further comprising a time-keeping section to keep a time and date,
wherein the control section compresses the job information stored in the second storage section to store the compressed job information into the second storage section, at the time when a date has changed by the time-keeping section, as the predetermined timing.

7. The image forming apparatus of claim 1 further comprising:
a display section to display the job information; and
an input section to receive an instruction to display the job information stored in the second storage section on the display section,
wherein when the control section receives the instruction to display the job information stored in the second storage section from the input section, the control section searches for the job information for which the instruction to display the job information stored in the second storage section is received, expands the job information if the job information is compressed, stores the expanded job information or the searched uncompressed job information into the first storage section, and displays the job information stored in the first storage section on the display section.

8. A method for managing job information in an image forming apparatus which includes a first storage section and a second storage section larger in capacity than the first storage section, the method comprising:
storing the job information of a completely executed job into the first storage section;
storing the job information stored in the first storage section into the second storage section; and
compressing the job information stored in the second storage section to store the compressed job information into the second storage section.

9. The method for managing of claim 8, wherein the job information stored in the first storage section is stored into the second storage section every time a predetermined time has passed.

10. The method for managing of claim 8, wherein the job information stored in the second storage section is compressed to be stored into the second storage section at the time when the image forming apparatus is turned on.

11. The method for managing of claim 8, wherein the job information stored in the second storage section is compressed to be stored into the second storage section at the time when a date has changed.

12. The method for managing of claim 8, wherein after the job information stored in the second storage section is compressed to be stored into the second storage section, the job information which has not compressed is deleted from the second storage section.

13. The method for managing of claim 8 further comprising searching the job information stored in the second storage section, expanding the job information to store the expanded job information into the first storage section if the job information is compressed or storing the searched job information into the first storage section without expanding if the job information is not compressed, and displaying the job information stored in the first storage section on the display section, when an instruction to display the job information stored in the second storage section is received.
